(19) United States
(12) Patent Application Publication
(10) Pub. No.: US 2006/0099454 A1
(43) Pub. Date: May 11, 2006

(54) Method for producing electromagnetic wave absorbing sheet, method for classifying powder, and electromagnetic wave absorbing sheet

(75) Inventors: Hiroki Morikoshi, Tokyo (JP); Katsuhiko Wakayama, Tokyo (JP)

Correspondence Address: HOGAN & HARTSON L.L.P., 500 S. GRAND AVENUE, SUITE 1900, LOS ANGELES, CA, 90071-2611, US

(73) Assignee: TDK CORPORATION

(21) Appl. No.: 11/269,496

(22) Filed: Nov. 7, 2005

(30) Foreign Application Priority Data
Nov. 8, 2004 (JP) 2004-323339
Nov. 8, 2004 (JP) 2004-323340
Nov. 8, 2004 (JP) 2004-323341

(51) Int. Cl. H01F 1/03; B32B 15/00

(52) U.S. Cl. 428/692.1; 148/104

(57) ABSTRACT

An object of the present invention is to provide a method for producing an electromagnetic wave absorbing sheet with properties thereof further improved. A treated powder P0 pulverized and flaked in a pulverizing step is placed in a centrifugal gas-flow classifier 50. The treated powder is classified into a flaky soft magnetic metal powder P1 and a non-flaky powder P2 on the basis of the difference between the centrifugal force and the drag acting on each of these powders in a gas flow circling in a chamber 51. The non-flaky powder P2 is eliminated and the flaky soft magnetic metal powder P1 is used to form an electromagnetic wave absorbing sheet, the performances of the electromagnetic wave absorbing sheet being thereby improved. The classified non-flaky powder P2 is preferably recycled as the raw material powder used in the pulverizing step.

### BACKGROUND OF THE INVENTION

1. Field of the Invention

The present invention relates to a method for producing an electromagnetic wave absorbing sheet to be used in electromagnetic noise suppression parts and the like.

2. Description of the Related Art

Electronic devices including digital electronic devices typified by personal computers, game machines and portable information terminals are undergoing adoption of high density due to adoption of high frequencies and high performances in circuits, in such a way that passive elements tend to suffer adverse effects of active elements such as semiconductors which emit noises. For the purpose of suppressing such adverse effects, ferrite cores and electromagnetic wave absorbers applicable in quasi-microwave bands have hitherto been used. However, downsizing of electronic devices comes to require downsizing, thinning and performance enhancing of noise suppression parts.

On the other hand, it is an important issue to meet the noise standards in relatively low frequencies in the vicinity of 100 MHz in order to meet the EMC standards. Consequently, demand for electromagnetic wave absorbers and compact EMI suppression parts applicable in such frequency bands is expanding.

Accordingly, there has been proposed a method for producing a composite magnetic sheet which is lowered in resonance frequency and can attain a high permeability in frequencies of 100 MHz or less through producing the sheet as follows: a flaky magnetic powder is reduced in residual stress by subjecting it to annealing treatment, then oriented along the in-plane directions, pressurized along the direction perpendicular to the sheet plane at a temperature equal to or higher than the glass transition temperature Tg of the organic binder (see, for example, Japanese Patent Laid-Open No. 2000-4097). However, such a composite magnetic sheet as made of an organic binder and a flaky magnetic powder gives permeability at most of the order of 30 at 100 MHz, and is hardly able to provide a high-permeability.

In addition, there has been proposed a method for producing a dust core in which a flaky soft magnetic powder is used and a plate-like product is formed by extrusion molding (see, for example, Japanese Patent Laid-Open No. 11-74140). This method has an advantage such that the permeability is enhanced owing to the orientation of the flaky soft magnetic powder along the extrusion direction; however, if a sheet thinner than 0.4 mm is tried to produce, extrusion through a narrow nozzle and pulling out there from for thinning by applying tension are needed to be carried out at the same time, making a high permeability hardly attainable. More specifically, flexibility sufficient to allow such pulling out at the time of the extrusion through a narrow nozzle requires an increased amount of resin so as to decrease the viscosity at the extrusion temperature, and hence the loaded amount of the magnetic powder is inevitably decreased, making a high permeability unobtainable.

In addition, there has been proposed a method in which a print lamination method and a doctor blade method are adopted for thinning without invoking extrusion (see, for example, Japanese Patent Laid-Open No. 11-176680).

Japanese Patent Laid-Open No. 11-176680 discloses a method for producing a core in which a 500 μm or less thick sheet has been prepared by means of a print lamination method by use of a flaky soft magnetic metal powder having an aspect ratio of 5 to 40 and a binder, such sheets are laminated to form a 10 mm or less thick laminate, the laminate is subjected to compression molding, and the thus molded laminate is blanked to produce a core. However, even if this method is adopted, a large amount of organic binder is used in addition to solvents, hence it is difficult to make the packing density of the soft magnetic metal powder exceed 75%, stress degradation due to forming is inevitable, no heat treating capable of effectively eliminating the residual stress can be applied, and consequently, no high permeability can be obtained at high frequencies in the vicinity of 100 MHz.

Japanese Patent Laid-Open No. 11-176680 also discloses a method for producing a composite magnetic material in which a deposition is made using a slurry-like mixture composed of a flaky soft magnetic powder, a binder and a solvent. This method is characterized in that the composite magnetic material is produced in such a way that no stress deformation is once more exerted on the flaky soft magnetic powder from which the stress deformation has been eliminated; however, such a method exerts no deformation stress on the flaky powder itself, hence makes it difficult to make the packing density of the material large, and has a drawback that the generation of stress caused by the curing contraction of the resin is inevitable in principle and other drawbacks, and consequently it can not be expected to obtain a high permeability at high frequencies in the vicinity of 100 MHz.

### SUMMARY OF THE INVENTION

Any of conventional techniques is based on the technical concept that a flaky soft magnetic metal powder is made to have a small residual stress, and thereafter, particular consideration is made so as not to exert excessive stress on this flaky soft magnetic metal powder in the molding step. Such a technical concept has double drawbacks in the sense that it substantially can not lead to a large packing density of the metal powder, and additionally it cannot give a decreased residual stress in the molded body, thus imposing a limit to improvement of the complex permeability over high frequency bands ranging from a few 10 MHz to a few GHz.

In this connection, in Japanese Patent Laid-Open No. 2002-289414, the present inventors have already proposed a composite magnetic material constituted in such a way that the particles of a flaky soft magnetic metal powder each having an insulating film formed on the surface thereof are compression bonded to each other, and consequently an insulating phase constituted with the insulating film is interposed between the soft magnetic metal phases constituted with the flaky soft magnetic metal powder. According to such a composite magnetic material, the packing density of the soft magnetic metal phase in the composite magnetic material can be made to be 50% or more, and the composite magnetic material can be made to give a 5 μm to 0.4 mm thick sheet.

For such composite magnetic materials, improvement of the properties thereof is constantly required.

The present invention has been achieved on the basis of the technical problems described above, and takes as its object the provision of a method for producing an electromagnetic wave absorbing sheet with properties thereof further improved and the provision of others.

The present inventors have made diligent investigations on the details of the processes for producing such electromagnetic wave absorbing sheets as described above for the purpose of further improving the properties thereof.

In the course of such investigations, it has been found that at the time when a flaky soft magnetic metal powder has been prepared, the flaky soft magnetic metal powder contains an insufficiently flaked powder (hereinafter referred to as “a non-flaky powder”), and this non-flaky powder affects seriously the degradation of the properties.

Under these circumstances, the present invention has attained a method for producing an electromagnetic wave absorbing sheet, comprising the steps of: obtaining a treated powder by subjecting a raw material powder to a pulverizing and flaking treatment; classifying the treated powder into a soft magnetic metal powder (a) having an aspect ratio of a specified value or more and a soft magnetic metal powder (b) having an aspect ratio less than the specified value; forming an insulating film on the surface of the soft magnetic metal powder (a); producing a sheet-like product by bonding the particles of the soft magnetic metal powder (a) to each other through applying pressure under the condition such that there is heaped the soft magnetic metal powder (a) having the insulating film formed thereon; and heat treating the sheet-like product.

In this way, the soft magnetic metal powder (b) having an aspect ratio less than the specified value is removed from the treated powder, and only the soft magnetic metal powder (a) is used to produce an electromagnetic wave absorbing sheet, and thus the properties of the sheet concerned can be improved.

In this connection, the classification of a flaky soft magnetic metal powder has hitherto been carried out in the step of preparing the flaky soft magnetic metal powder by use of a sieve or the like for the purpose of uniformizing the particle sizes of the flaky soft magnetic metal powder. However, classification with a sieve hardly removes a non-flaky powder because not only the flaky soft magnetic metal powder but also the non-flaky powders pass through the sieve.

Accordingly, the step of classifying a treated powder is preferably carried out by placing the treated powder in a gas flow circling in a chamber. When the treated powder is placed in a gas flow circling in a chamber, the treated powder having a smaller aspect ratio more easily moves toward the outer periphery part in the chamber than the treated powder having a larger aspect ratio because the drag opposing the centrifugal force depends on the aspect ratio, and more specifically, the larger is the aspect ratio, the larger is the drag. Consequently, the soft magnetic metal powder (a) can be recovered from the inner periphery part in the chamber, and the soft magnetic metal powder (b) can be recovered from the outer periphery part in the chamber.

It has been found that the particle shape nearly the same as that of the raw material powder is maintained in the soft magnetic metal powder (b) remaining after recovering of the soft magnetic metal powder (a) from the treated powder. Accordingly, the soft magnetic metal powder (b) can be recycled as the raw material powder used in the step of obtaining the treated powder. In this way, the soft magnetic metal powder (b) can be effectively used without discarding it.

The technical concept that a powder is placed in a gas flow circling in a chamber to be classified with the aid of centrifugal force can be applied to classification of not only the soft magnetic metal powders (a) and (b) but various powders.

In other words, an aspect of the present invention is a method for classifying a powder, comprising: placing a mixture of a first powder and a second powder different from each other in shape in a gas flow circling in a chamber; and classifying the first powder and the second powder by recovering the first powder from the inner periphery part in the chamber and by recovering the second powder from the outer periphery part in the chamber.

In this case, the first powder and the second powder different from each other in shape can be classified into the first and second powders on the basis of the difference between the drag and the centrifugal force acting on each of the first and second powders in the gas flow.

No particular constraint is imposed on the first and second powders as far as the drags acting on these powders in the gas flow are different from each other owing to the shape difference therebetween; however, the present invention is particularly effective when the first powder is larger in aspect ratio than the second powder. When such first and second powders different from each other in aspect ratio are placed in the gas flow circling in the chamber, the drags opposing the centrifugal forces acting on the first and second powders are different from each other, and hence the second powder having a smaller aspect ratio moves more easily toward the outer periphery part in the chamber owing to the centrifugal force, and consequently the first powder having a larger aspect ratio than that of the second powder can be recovered from the inner periphery part in the chamber.

It is to be noted that the first and second powders preferably have nearly the same particle masses. In other words, the method concerned can be effectively applied to the classification in the case where raw material powders having nearly the same particle sizes and nearly the same qualities are flaked. Obviously, the method concerned is effective not only in recovering the first powder having a larger aspect ratio from the mixture, but in recovering the second powder having a smaller aspect ratio.

Also obviously, the method concerned is particularly effective in classifying the flaky soft magnetic metal powder from the insufficiently flaked powder in the case where the mixture is a soft magnetic metal powder to be used as a raw material for a magnetic layer having an electromagnetic wave absorptivity in the electromagnetic wave absorbing sheet.

In the present invention, the classification is carried out with the aid of a gas flow, and accordingly, a perfect classification is not necessarily expected, and hence some mixing of the soft magnetic metal powder (a) and the soft magnetic metal powder (b) and some mixing of the first and second powders are to be accepted.

By applying the above described techniques of the present invention, there can be obtained an electromagnetic wave absorbing sheet, comprising: a magnetic layer formed by laminating in layers particles of the flaky soft magnetic metal powder having an insulating film formed on the surface thereof in the thickness direction; and an insulating layer formed of an insulating material, wherein the flaky soft magnetic metal powder comprises the particles of the flaky soft magnetic metal powder each having an aspect ratio of 160 to 1250 in a content of 93 wt % or more. Such a larger content of the flaky soft magnetic metal powder having a high aspect ratio improves the properties of the electromagnetic wave absorbing sheet as compared to the case where the magnetic layer is formed in a manner incorporating the non-flaky powder that is not sufficiently flaked.

According to the method for producing an electromagnetic wave absorbing sheet of the present invention, an electromagnetic wave absorbing sheet having higher performances having not hitherto been attained can be obtained by forming an electromagnetic wave absorbing sheet which is made to contain a large amount of a soft magnetic metal powder (a) larger in aspect ratio through eliminating a soft magnetic metal powder (b) smaller in aspect ratio from a treated powder pulverized and flaked.

The classification concerned can be easily carried out by placing the treated powder in a circling gas flow.

Additionally, the raw material powder can be effectively used by recycling the soft magnetic metal powder (b) eliminated by the classification, leading to advantageous effects such as reduction of cost and waste.

According to the method for classifying a powder of the present invention, a first powder and a second powder different in shape from each other can be easily classified in a circling gas flow.

### BRIEF DESCRIPTION OF THE DRAWINGS

FIGS. 1A and 1B show schematic sectional views illustrating the configurations of the electromagnetic wave absorbing sheets in an embodiment;

FIG. 2 is a schematic diagram illustrating the magnetic layer constituting an electromagnetic wave absorbing sheet, wherein the an insulating film (an insulating phase) is formed on the surface of each of the particles of a flaky soft magnetic metal powder (a soft magnetic metal phase);

FIG. 3 is a flowchart showing the production steps according to the embodiment;

FIGS. 4A and 4B show the structure of a classifying apparatus for use in classifying a flaky soft magnetic metal powder and a non-flaky powder, wherein FIG. 4A illustrates a vertical sectional view thereof and FIG. 4B illustrates a horizontal sectional view thereof;

FIG. 5A shows the relation between the centrifugal force and the drag acting on a particle of a flaky soft magnetic metal powder, and FIG. 5B shows the relation between the centrifugal force and the drag acting on a particle of a non-flaky powder;

FIG. 6 shows a SEM micrograph of a treated powder pulverized and flaked;

FIG. 7 is a graph showing the frequency-permeability characteristics depending on the presence/absence of the classifying treatment;

FIG. 8A shows a SEM micrograph taken for a treated powder recovered after classification in the inner periphery part of a classifier, and FIG. 8B shows a SEM micrograph taken for a treated powder recovered after classification in the outer periphery part of the classifier;

FIG. 9 is a table showing the contents in a treated powder having been classified in Example 1 respectively corresponding to the aspect ratio sections as specified therein;

FIG. 10 is a table showing the relation between the heat treating temperature and the permeability of a magnetic sheet obtained in Example 2;

FIG. 11 is a table showing the relation between the heat treating time and the permeability of a magnetic sheet obtained in Example 2;

FIG. 12 is a table showing the relation between the heat treating temperature increase rate and the permeability of a magnetic sheet obtained in Example 2;

FIG. 13 is a table showing the relation between the heat treating temperature decrease rate and the permeability of a magnetic sheet obtained in Example 2;

FIG. 14 is a graph showing the relations between the molding density and the permeability in Examples;

FIG. 15 is a table showing the particle size distribution of the soft magnetic metal powder used in Example 3;

FIG. 16 is a table showing the measurement results of the coercive force (Hc), after heat treating, of the soft magnetic metal powder in Example 3;

FIG. 17 is a graph showing the relation between the weight ratio of the fraction of the flaky powder falling in a particle-size range from 45 to 125 μm and the μ′ (10 MHz) in electromagnetic wave absorbing sheets obtained in Example 3;

FIG. 18 is a graph showing the relation between the weight ratio the fraction of the flaky powder falling in a particle-size range from 45 to 125 μm and the μ′ (100 MHz) in electromagnetic wave absorbing sheets obtained in Example 3;

FIG. 19A is a micrograph showing an exterior appearance of a flaky powder of No. 1, and FIG. 19B is a micrograph showing an exterior appearance of a flaky powder of No. 5;

FIG. 20 is a graph showing the relations between the weight ratios of the flaky powders respectively having particle sizes ranging from 0 to 32 μm, 32 to 38 μm, and 38 to 45 μm and the μ′ (10 MHz) in electromagnetic wave absorbing sheets obtained in Example 3; and

FIG. 21 is a graph showing the relations between the weight ratios of the flaky powders respectively having particle sizes ranging from 0 to 32 μm, 32 to 38 μm, and 38 to 45 μm and the μ′ (100 MHz) in electromagnetic wave absorbing sheets obtained in Example 3.

### DETAILED DESCRIPTION OF THE PREFERRED EMBODIMENT

The embodiment of the present invention will be described below.

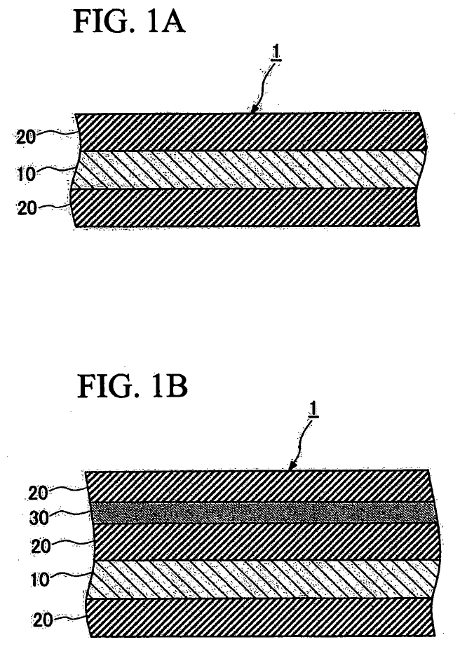

As shown in FIG. 1A, an electromagnetic wave absorbing sheet 1 of the present embodiment has a structure in which both sides of a magnetic layer 10 each have an insulating layer 20. Here, the magnetic layer 10 preferably is 5 to 100 μm in total thickness. The insulating layers 20 each preferably are 50 μm or less, and more preferably 15 μm or less in total thickness.

As shown in FIG. 1(b), the electromagnetic wave absorbing sheet 1 may also have a conductive layer 30 on one of the insulating layers 20 arranged on both sides of the magnetic layer 10 in such a way that the conductive layer 30 contacts the surface of the insulating layer 20 concerned opposite to the surface of the insulating layer 20 contacting the magnetic layer 10. The conductive layer 30 is formed of a conductive material such as copper or carbon, and serves to ground the electromagnetic wave absorbing sheet 1. In this case, the conductive layer 30 is further coated with another insulating layer 20 as an additional insulating layer.

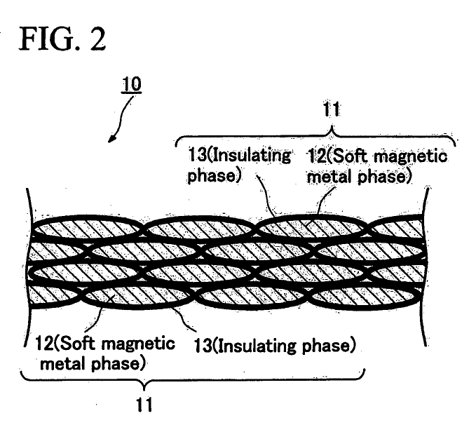

FIG. 2 schematically shows the magnetic layer 10 constituting the electromagnetic wave absorbing sheet 1. The magnetic layer 10 is formed of a large number of particles of the magnetic powder 11, wherein the particles undergo plastic deformation to densely entwine with each other.

Each of the individual particles of the magnetic powder 11 is a particle of a composite magnetic material composed of a soft magnetic metal phase 12 composed of a flaky soft magnetic metal powder and an insulating phase 13 composed of an insulating film formed on the surface of the soft magnetic metal phase 12. Accordingly, the insulating phase 13 is interposed between the soft magnetic metal phases 12 contacting each other. Thus, the magnetic layer 10 has a sheet-like structure in which the particles of the flaky soft magnetic metal powder having the insulating film on the surface thereof are laminated in layers in the thickness direction of the magnetic layer to give a predetermined thickness to the magnetic layer.

First, description will be made on the flaky soft magnetic metal powder constituting the soft magnetic metal phase 12. Here, “flaky” means that the aspect ratio (the ratio between the major axis and minimum thickness of the powder particle) is larger than 1.

In the flaky soft magnetic metal powder, the soft magnetic metal is permalloy (Fe—Ni alloy), superpermalloy (Fe—Ni—Mo alloy), sendust (Fe—Si—Al alloy), Fe—Si alloy, Fe—Co alloy, Fe—Cr alloy, Fe—Cr—Si alloy or the like; the aspect ratio concerned falls within a range preferably from 160 to 1250, and more preferably 450 to 1250.

The particle thickness (the thickness before rolling) of the flaky soft magnetic metal powder falls within a range preferably from 0.1 to 1.0 μm, and more preferably from 0.2 to 0.5 μm. It is difficult to make the particle thickness of the flaky soft magnetic metal powder less than 0.1 μm from the viewpoint of production, and it is also difficult to handle a powder having such a small particle thickness. When the particle thickness of the flaky soft magnetic metal powder exceeds 1.0 μm, the degradation of the magnetic properties in high frequencies is unpreferably caused. The particle thickness is almost unchanged even when the particles of the flaky soft magnetic metal powder are compression bonded to each other. Consequently, even after this compression bonding, the particle thickness of the flaky soft magnetic metal powder still falls within the range from 0.1 to 1.0 μm.

The particle major axis of the flaky soft magnetic metal powder falls within a range preferably from 16 to 125 μm, and more preferably from 45 to 125 μm. It is particularly preferable to use a flaky soft magnetic metal powder in which the particle major axis of a 40 wt % or more fraction thereof falls within a range from 45 to 125 μm, because the major axis falling within this range is preferable for the purpose of obtaining high permeability properties as will be shown in Examples to be described later. Here, it should be noted that the whole flaky soft magnetic metal powder used is not required to have major axis values falling within the range from 45 to 125 μm; as will also be shown in Examples to be described later, desired permeability properties can be obtained as long as a 40 wt % or more fraction of the flaky soft magnetic metal powder used gives major axis values falling within this range. The content of this fraction of the flaky soft magnetic metal powder giving major axis values falling in the range from 45 to 125 μm is set to be preferably 50 wt % or more, and more preferably 70 wt % or more. A judgment as to whether the content concerned of this fraction is 40 wt % or more or not is to be made on the basis of the weight ratio of this fraction of the flaky soft magnetic metal powder giving major axis values falling in the range from 45 to 125 μm. No particular constraint is imposed on the flaky soft magnetic metal powder as long as the following condition is satisfied: the content of the fraction thereof giving major axis values falling within the range from 45 to 125 μm is 40 wt % or more. In this connection, even if this condition is not satisfied in the classifying step to be described later, it suffices that this condition will be finally satisfied by thereafter classifying with a sieve.

Next, an insulating film constituting an insulating phase 13 will be described below.

Although it is ideal that a uniform insulating film is formed on the whole surface of the particles of the flaky soft magnetic metal powder as shown in FIG. 2, it suffices that an insulating film capable of sufficiently functioning as the insulating phase 13 is formed on the surface of the particles of the flaky soft magnetic metal powder after compression bonding even if some portions of the surface remain exposed without the insulating film formed thereon.

The flaky soft magnetic metal powder and an insulating material are mixed together, and a predetermined treatment is applied thereto to form the insulating film on the surface of the particles of the flaky soft magnetic metal powder. As the insulating material, organic insulating materials and inorganic insulating materials can be used. More specifically, preferable are inorganic polymers such as polysilazane materials including perhydropolysilazane. Silane coupling agents, titanate coupling agents, and inorganic insulating materials such as silica sol, titania sol, magnesia sol, alumina sol, powdery glass and boron nitride can also be used as the insulating materials; these materials may be used in combination with perhydropolysilazane.

The insulating layer 20 shown in FIG. 1 is a layer formed of an insulating material; for example, it is formed by bonding a resin sheet onto the magnetic layer 10 or by applying an insulating material onto the surface of the magnetic layer 10.

A resin is preferable as the insulating material imparting electric insulation to the surface of the electromagnetic wave absorbing sheet 1, preferred among such resins being resins excellent in strength and insulation, and further in flame retardance. Specific examples of the materials forming the insulating layer 20 may include resins such as phenolic resin, urea resin, melamine resin, Teflon (registered mark), polyimide, polyvinyl chloride, flame-retardant polyethylene, flame-retardant polypropylene, flame-retardant polystyrene, polyphenylene sulfide, flame-retardant PET, flame-retardant PBT, flame-retardant polyolefin, silicone resin and epoxy resin; when a flame-retardant is added for the purpose of improving the flame retardance, non-halogen retardants are preferably used.

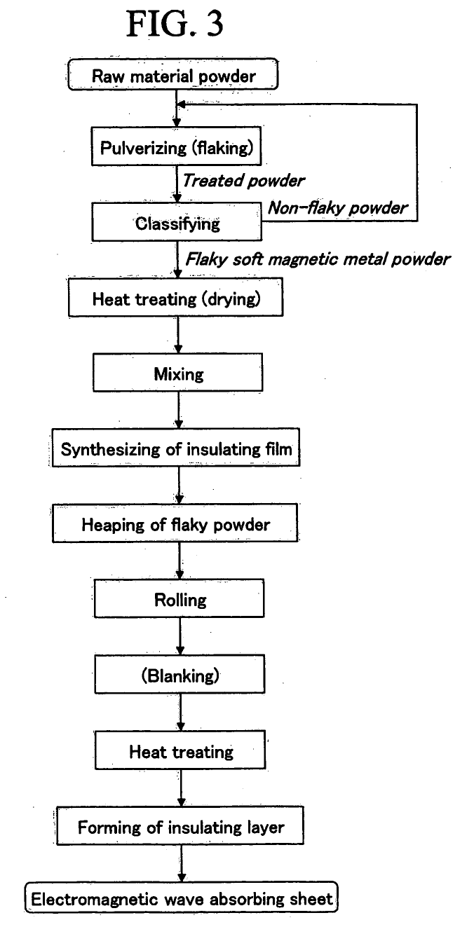

FIG. 3 is a flowchart showing the steps for producing the electromagnetic wave absorbing sheet 1 according to the present embodiment.

At the beginning, in a pulverizing step, an atomized powder of a soft magnetic metal having a mean particle size of 10 to 100 μm, as a raw material, is pulverized in an organic solvent such as toluene, for example, with a stirring mill to yield a flaky soft magnetic metal powder having a particle thickness value of 0.1 to 1.0 μm and an aspect ratio of 160 to 1250.

The flaky soft magnetic metal powder obtained as described above contains non-flaky powder, which is insufficiently pulverized and flaked. The treated powder (a mixture composed of the flaky soft magnetic metal powder and the non-flaky powder) having been subjected to the pulverizing step is classified into the flaky soft magnetic metal powder and the non-flaky powder (a classifying step).

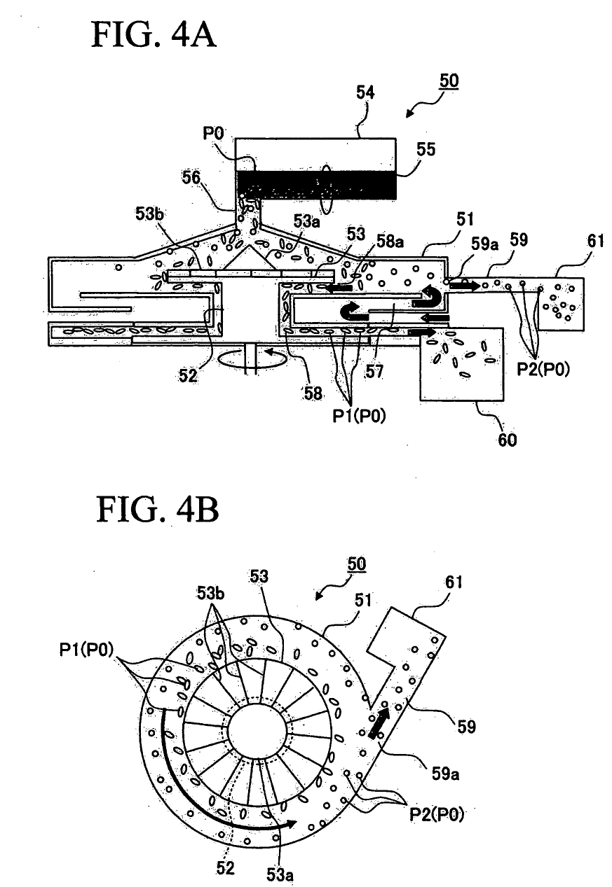

For this classification, it is preferable to use a centrifugal gas-flow classifier 50 as shown in FIGS. 4A and 4B. The classifier 50 is equipped with a rotor 52 that is driven by an unshown motor or the like in a chamber 51 nearly circular in plain view. A disc-shaped table 53 is fixed to the rotor 52. In the upper central portion of the chamber 51, there is arranged a feed pipe 56 for feeding a treated powder (a mixture) P0, having been subjected to the pulverizing and flaking, from a hopper 54 with the aid of a screw feeder 55 so as for the treated powder to drop onto the central portion of the table 53.

A conical projection 53a is arranged in the central portion of the upper surface of the table 53. A plurality of radially extending blades 53b are arranged on the outer periphery part of the projection 53a. Accordingly, when the rotor 52 is driven to rotate and the table 53 thereby rotates along a predetermined direction, the treated powder P0 fed in a descending manner from the feed pipe 56 is made to fly toward the outer periphery part from the table 53 owing to the centrifugal force acting on the powder.

In the chamber 51, there are formed a gas inlet 57 to feed a gas into the chamber 51, and beneath the table 53, an inner peripheral discharge flow channel 58 having an opening 58a in the inner periphery part of the chamber 51 and an outer peripheral discharge flow channel 59 having an opening 59a in the outer periphery part of the chamber 51. Within the chamber 51, when a gas such as air is fed into the chamber 51 from the gas inlet 57 with the aid of an unshown pump or the like, the fed gas is made to generate a spirally circling gas flow by the rotation of the table 53 having the blades 53b. Then, the gas is discharged outside from the inner peripheral discharge flow channel 58 and the outer peripheral discharge flow channel 59.

Thus, the treated powder P0 made to fly toward the outer periphery part from the table 53 is discharged outside from the inner peripheral discharge flow channel 58 and the outer peripheral discharge flow channel 59 with the aid of the gas flow. The inner peripheral discharge flow channel 58 and the outer peripheral discharge flow channel 59 are affixed with recovery vessels 60 and 61, respectively, to recover the discharged treated powder P0.

In the classifier 50, among the below described flaky and non-flaky powders constituting the treated powder P0 made to fly toward the outer periphery part from the table 53, the flaky soft magnetic metal powder (a soft magnetic metal powder (a), a first powder) P1 having a larger aspect ratio (the major axis to minimum thickness ratio=major axis/minimum thickness in the treated powder P0) is sucked into the inner peripheral discharge flow channel 58, and the non-flaky powder (a soft magnetic metal powder (b), a second powder) P2 having a smaller aspect ratio and being insufficiently flaked is discharged from the outer peripheral discharge flow channel 59, and thus the treated powder P0 can be classified into the flaky soft magnetic metal powder P1 and the non-flaky powder P2.

Here, the aspect ratio to be used as a criterion for classification can be set at approximately 160. In other words, a fraction of the treated powder P0 having aspect ratios of 160 or more can be classified as the flaky soft magnetic metal powder P1, and a fraction of the treated powder P0 having aspect ratios less than 160 can be classified as the non-flaky powder P2.

Now, the mechanism of the above classification will be discussed. In the classifier 50 as described above, the centrifugal force directing toward the outer periphery part of the chamber 51 and the force opposite to the centrifugal force act on the treated powder P0 made to fly toward the outer periphery part from the table 53.

The centrifugal force F1 is represented by
F1=mrω²

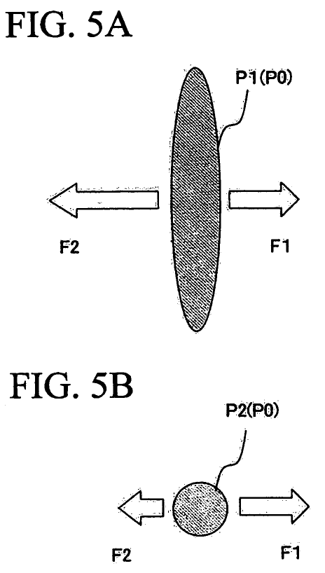

The treated powder P0 in the chamber 51 is composed of raw material powders having approximately the same particle sizes, and hence having approximately the same masses; the radius r and the angular velocity ω of the table 53 are constant; and hence, as shown in FIGS. 5A and 5B, the centrifugal force F1 acting on the flaky soft magnetic metal powder P1 is approximately the same as that acting on the non-flaky powder P2.

On the other hand, the drag F2 is represented by
F2∝SU²

The flow velocity U of the gas in the chamber 51 is constant and the same both for the flaky soft magnetic metal powder P1 and for the non-flaky powder P2. The projected particle area S of the treated powder P0 largely varies between the flaky soft magnetic metal powder P1 and the non-flaky powder P2. The particles of the flaky soft magnetic metal powder P1 take various orientations (behave like leaves); with certain temporal probabilities, some of the orientations will give drastically larger projected areas S associated with the gas flow than the projected areas S for the particles of the non-flaky powder P2; and hence, the drag. F2 acting on the flaky soft magnetic metal powder Pi is increased.

Thus, among the below described flaky and non-flaky powders constituting the treated powder P0 made to fly toward the outer periphery part from the table 53, the non-flaky powder P2 having a smaller drag F2 largely undergoes the effect of the centrifugal force F1 and hence easily reaches the outer periphery part in the chamber 51 to be discharged from the outer peripheral discharge channel 59. On the contrary, the flaky soft magnetic metal powder P1 largely undergoes the effect of the drag F2 while flying like leaves, and hence, is not transferred to the outer periphery part in the chamber 51 unlike the non-flaky powder P2, and is sucked into the inner peripheral discharge channel 58 at the outer periphery part of the table 53 in a manner riding on the gas flow heading for the inner peripheral discharge channel 58.

In this way, the classifier 50 can carry out the classification into the flaky soft magnetic metal powder P1 and the non-flaky powder P2.

The flaky soft magnetic metal powder P1 sucked into the inner peripheral discharge channel 58 is recovered into the recovery vessel 60 to be supplied to a subsequent step, and the non-flaky powder P2 discharged from the outer peripheral discharge channel 59 is recovered into the recovery vessel 61.

Here it is preferable that the non-flaky powder P2 recovered in the recovery vessel 61 is recycled as the raw material powder used in the pulverizing step.

Now, the flaky soft magnetic metal powder P1 having been classified undergoes a heat treating step after the pulverizing step. In this heat treating step, the flaky soft magnetic metal powder P1 is heat treated in an inert gas (for example, nitrogen) or hydrogen, for example, at 600° C. for 60 min. In this way, the soft magnetic metal powder is dried, and additionally the strain generated in the pulverizing step to flatten the soft magnetic metal powder is removed and the oxygen and carbon mixed into the soft magnetic metal powder in the course of pulverizing are also removed. This heat treating step is not necessarily indispensable. However, it is preferable that the flaky soft magnetic metal powder P1 has a small strain (magnetostriction), and hence it is preferable that the strain of the flaky soft magnetic metal powder P1 is removed by heat treating the flaky soft magnetic metal powder P1 in advance of the insulating step to be described later.

Next, a mixing step and an insulating film synthesizing step are carried out. In these steps, the flaky soft magnetic metal powder Pi and an insulating material (liquid or fine powder) are mixed together, and an insulating film is synthesized on the basis of a predetermined method to prepare an insulation-treated powder, namely, a magnetic powder 11 in which an insulating film is formed on the surface of the particles of the flaky soft magnetic metal powder P1. The insulating film synthesizing step varies in processes depending on the type of the insulating material. Description will be made below on the individual processes involved in the cases where the insulating material are (1) perhydropolysilazane, (2) a coupling agent (one of silane, titanate and other coupling agents), and (3) one of other oxide sols or BN (boron nitride).

(1) In the case where the insulating material is perhydropolysilazane, the flaky soft magnetic metal powder P1 and perhydropolysilazane are mixed together by use of a mixer such as a stone mill or a table kneader. After mixing, the mixture thus obtained is heat treated, for example, while being maintained in the air or in nitrogen at 300° C. for 60 min. Perhydropolysilazane is converted into SiO₂ when heat treated in the air, and into Si₃N₄ when heat treated in nitrogen.

(2) In the case where the insulating material is a coupling agent (one of silane, titanate and other coupling agents), a wet treatment is adopted to coat the surface of the particles of the metal powder. The wet treatment is a method in which while the flaky soft magnetic metal powder Pi is mixed under stirring in the coupling agent diluted by a factor of 50 to 100 with a solvent, a surface treatment is carried out by volatilizing the solvent.

(3) In the case where the insulating material is one of other oxide sols or BN, the flaky soft magnetic metal powder P1 and the insulating material are directly mixed together (dry mixed) by use of a mixer.

Successively, the step of heaping the flaky powder is carried out. In this step; at the beginning, the magnetic powder 11 is nearly uniformly heaped on a substrate while being sifted with a sieve to drop onto the substrate. At this time, the feeding of the magnetic powder 11 into the sieve can be automatically carried out with a feeder or the like. Alternatively, without using a sieve, the magnetic powder 11 can be heaped onto the substrate by spraying the magnetic powder 11 onto the substrate with a spray.

In this step of heaping the flaky powder, by altering the particle size of the insulation-treated powder through appropriately selecting the mesh size of the sieve, the magnetic properties of the composite magnetic material to be finally obtained can be set to fall within an optional range. In this connection, it is preferable that the particle size (the major axis) of the insulation-treated powder is set in such a way that a fraction thereof having particle sizes of 45 to 125 μm amounts to 40 wt % or more.

The next is the rolling step. In this rolling step, rolling is applied on the substrate with the magnetic powder 11 nearly uniformly heaped thereon with a rolling roll to orient the particles of the magnetic powder 11 to be parallel to the substrate. In this rolling, the particles of the flaky soft magnetic metal powder P1 with the insulating film formed thereon (the magnetic powder 11) are compression bonded to each other. In this way, a magnetic sheet (a sheet-like product) forming a 5 to 100 μm thick magnetic layer 10 can be obtained.

It is preferable to roll the magnetic powder 11 heaped on the substrate in such a way that after rolling, the molding density (the weight of the magnetic powder 11 per unit volume) in the magnetic sheet is 5.2 g/cm³ or more, and furthermore, 5.5 g/cm³ or more. For that purpose, the load (pressure) applied in the rolling roll is controlled when rolling is made.

The fact that the thickness of the magnetic sheet to form the magnetic layer 10 is made to be 5 to 100 μm is based on the following grounds. When the thickness of a sheet is smaller than 5 μm, sintering can attain a sufficiently large permeability for high frequencies, so that a composite magnetic material is scarcely required for such a sheet. On the other hand, another constraint comes from the fact that when the sheet thickness exceeds 100 μm, it comes to be difficult to house an electromagnetic wave absorbing sheet 1 having the magnetic layer 10 in a small space within the cases of an electronic device.

In the step of heaping a flaky powder and the step of rolling, the degree of orientation after rolling can be improved by allowing the magnetic powder 11 to freely fall from a holding container such as a sieve located above and 3 mm or more away from the surface of the substrate so as for the particles of the magnetic powder 11 to be in-plane oriented and by rolling subsequently.

Here, the rolling step is explained on the basis of an example of rolling, but this step is not limited to rolling. Other compression molding methods such as a pressing method may be used as long as such a method can apply a pressure sufficient to carry out plastic deformation of the flaky soft magnetic metal powder P1. However, from the viewpoint of pressurization, rolling is most preferable.

Thereafter, the magnetic sheet thus obtained may be subjected to blanking according to need (the blanking step).

Successively, the heat treating step is carried out. In the heat treating step, the magnetic sheet is placed in a heat treating furnace to be heat treated to relieve the residual strain after the plastic deformation of the flaky soft magnetic metal powder P1. For the purpose of avoiding the serious oxidation of the flaky soft magnetic metal powder P1, the heat treating atmosphere is preferably an atmosphere of an inert gas such as Ar, or an atmosphere of nitrogen or hydrogen.

The heat treating temperature (the stable temperature) falls in a range preferably from 500 to 800° C., more preferably from 500 to 620° C., and furthermore preferably 520 to 590° C. When the heat treating temperature is lower than 500° C., the relieving effect of the residual strain is small. On the other hand, the heat treating temperature exceeds 800° C., the insulation function of the insulating film formed on the surface of the particles of the flaky soft magnetic metal powder is impaired. By setting the heat treating temperature to fall within the range from 500 to 620, furthermore from 520 to 590° C., a high permeability can be obtained in a frequency band around 10 MHz or 100 MHz.

The heat treating time (the stable time) is set preferably at 40 min or more, and more preferably at 60 min or more. From the viewpoint of improving the production efficiency, the heat treatment time is set preferably to be as short as possible within an allowable range. Accordingly, the heat treating time is recommended to be of the order of 60 min.

The average temperature increase rate until the heat treating temperature is reached is preferably 18° C./min or less, more preferably 15° C./min or less, and furthermore preferably 10° C./min or less. In other words, a high permeability can be obtained in a high frequency band around 10 MHz or 100 MHz by increasing the temperature as slowly as possible. However, also in this case, from the viewpoint of improving the production efficiency, it is preferable to make the average temperature increase rate as high as possible within an allowable range.

The temperature decrease time after the heat treating is set so as for the average temperature decrease rate from the above described heat treating temperature to be preferably 3° C./min or less, and more preferably 2° C.//min or less. In this way, the time required for the temperature to be decreased down to a predetermine temperature (for example, about 60° C.) at which the furnace is opened to take out the magnetic sheet can be made to be about 160 min or more (for the decrease rate of 3° C./min) or about 240 min or more (for the decrease rate of 4° C./min). By decreasing the temperature as slowly as possible in this way, a high permeability can be obtained in a frequency band around 10 MHz or 100 MHz. However, also in this case, from the viewpoint of improving the production efficiency, it is preferable to make the temperature decrease rate as high as possible within an allowable range.

By passing through the above described steps, the 5 to 100 μm thick sheet-like magnetic layer 10 according to the present embodiment is obtained.

Next, the step of forming an insulating layer is carried out. In this step, an insulating layer 20 is formed on each of both sides of the magnetic layer 10.

For that purpose, the insulating layer 20 can be formed by bonding an insulating sheet formed beforehand in a sheet shape having a predetermined thickness onto the surface of the magnetic layer 10. Here, the insulating sheet to form the insulating layer 20 may be formed with the insulating materials as described above.

When the insulating sheet to form the insulating layer 20 is bonded to the magnetic layer 10, an adhesive applied onto the surface of the sheet-like magnetic layer 10 or applied onto the insulating sheet to form the insulating layer 20 may be used. Preferred as the adhesive are epoxy adhesives and silicone adhesives both having insulating property and heat resistance. In addition, just like in a laminate film, an adhesive layer is formed on the surface of the insulating sheet to form the insulating layer 20, and then this insulating sheet having such an adhesive layer can be bonded onto the sheet-like magnetic layer 10 by applying a pressing force. In this case, by applying heat when the sheet-like magnetic layer 10 is bonded onto the insulating layer 20 by applying a pressing force, there can be adopted a so-called thermo-compression bonding in which the adhesive layer in the insulating layer 20 is melted.

Alternatively, for the purpose of forming the insulating layer 20, it is also possible that such a material as described above is directly applied onto the surface of the magnetic layer 10 and cured. In other words, by coating with an insulating material, the insulating layer 20 is formed.

Preferred coating materials to be used in this case include resins such as silicone resin, silicon rubber, epoxy resin, epoxy/silicone composite resin, butyral resin, acrylic resin, ethyl cellulose resin, polypropylene resin, styrene/butadiene resin and polybutylene resin. The above described coupling agents and adhesives can also be used.

When a resin layer is formed as the insulating layer 20 on the surface of the magnetic sheet to form the magnetic layer 10, there can be appropriately adopted methods in which the magnetic sheet to form the magnetic layer 10 may be soaked into a resin, and a resin is sprayed onto the magnetic sheet to form the magnetic layer 10 with a spray. When the magnetic sheet to form the magnetic layer 10 is soaked into the a resin, a resin is diluted with one or more solvents such as toluene, xylene, ethanol and acetone to prepare a resin solution, and the magnetic sheet to form the magnetic layer 10 may be soaked in the resin solution for about 3 to 20 min.

By successively forming such an insulating layer 20 on each of both sides of the magnetic layer 10, the electromagnetic wave absorbing sheet 1 shown in FIG. 1A is obtained.

As described above, the treated powder P0 pulverized and flaked by passing through the pulverizing step can be classified into the flaky soft magnetic metal powder P1 and the non-flaky powder P2 by use of a centrifugal gas-flow classifier 50, and consequently, the non-flaky powder P2 is removed and the flaky soft magnetic metal powder P1 is used to form the electromagnetic wave absorbing sheet 1 and the properties thereof can thereby be improved.

In addition, the classified non-flaky powder P2 can be recycled as the raw material used in the pulverizing step. By once again pulverizing and flaking the non-flaky powder P2 recycled in this way, the total ratio of the flaky soft magnetic metal powder Pi which can be obtained from the initially fed raw material, namely, the yield ratio of the flaky soft magnetic metal powder P1 can be improved. Consequently, the raw material can be effectively used, and excellent advantages such as reduction of cost and waste are thereby provided.

In the magnetic sheet to form the soft magnetic layer 10 according to the present embodiment, the packing density of the soft magnetic metal phase 12, namely, the flaky soft magnetic metal powder can be made to amount to 75% or more. Accordingly, satisfactory magnetic properties can be obtained.

When a section of the magnetic sheet to form the soft magnetic layer 10 obtained according to the present invention was observed, the 0.1 to 1.0 μm thick particles of the flaky soft magnetic metal powder were verified to undergo plastic deformation, and the particles of the flaky soft magnetic metal powder were verified to be laminated in layers. In addition, the individual particles of the flaky soft magnetic metal powder were observed to have a structure in which these particles were insulated by oxides and/or nitrides. In other words, it was verified that the magnetic sheet to form the soft magnetic layer 10 of the present embodiment had a structure in which an insulating phase 13 was interposed between the layer-like soft magnetic metal phases 12. The magnetic sheet to form the soft magnetic layer 10 of the present embodiment has a structure, which can simultaneously attain a small demagnetization field and a small eddy current.

### EXAMPLE 1

In this example, a magnetic sheet (an electromagnetic wave absorbing sheet 1) was fabricated according to the above described steps, and the properties thereof were checked. The results thus obtained are presented.

As explained in a diagram of the production steps shown in FIG. 3, a water atomized 2 Mo permalloy powder (80 Ni-2 Mo-bal.Fe (mol %)) of about 30 μm in mean particle size, as a soft magnetic metal powder; was pulverized and flaked in a medium stirring mill using toluene as solvent for 35 min, to yield a treated powder.

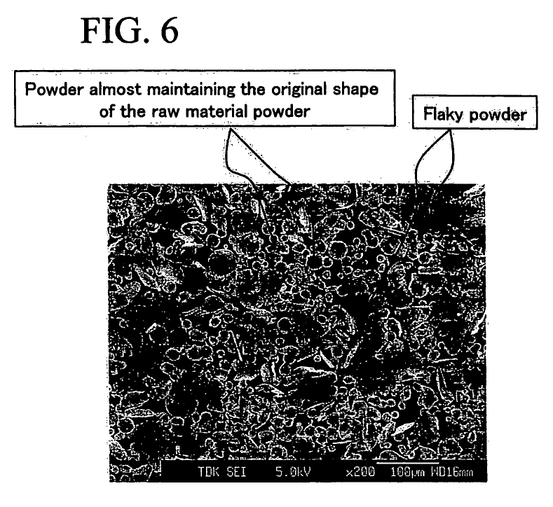

The obtained treated powder was dried, and then observed with a scanning electron microscope (SEM). The observed image is shown in FIG. 6.

As shown in FIG. 6, the treated powder was a mixture composed of a flaky powder and a powder (namely, a non-flaky powder) nearly maintaining the shape (a spherical shape) of the raw material powder.

Successively, the treated powder was subjected to the insulating film synthesis treatment by using perhydropolysilazane (polysilazane NL110A-20, manufactured by Clariant Japan Co., Ltd.) as the insulating material to form the insulating phase 13. In this treatment, the addition amount of perhydropolysilazane to the flaky Mo permalloy powder was set at 4.5 wt %. The flaky Mo permalloy powder and perhydropolysilazane were mixed together at room temperature for about 60 min by use of a mixer. Then, the mixture was maintained in the air at 300° C. for 60 min to convert perhydropolysilazane to SiO₂ to form an insulating film on the surface of the particles of the flaky Mo permalloy powder.

Then, the above described flaky powder subjected to insulating treatment was heaped nearly uniformly on a stainless steel substrate while sifting the flaky powder by use of a sieve (opening: 125 μm) located 10 to 20 mm above the substrate. The stainless steel substrate was rolled bypassing it through a two-stage cold rolling roll of 50 mm in roll diameter, and the individual particles of the flaky powder were thereby oriented parallel to the substrate to form an about 50 μm thick sheet.

Successively, this sheet was heat treated in an atmosphere of nitrogen for the purpose of relieving the strain generated in the pulverizing step to flatten the metal powder and the strain generated in rolling.

The permeability of the magnetic sheet thus obtained was measured.

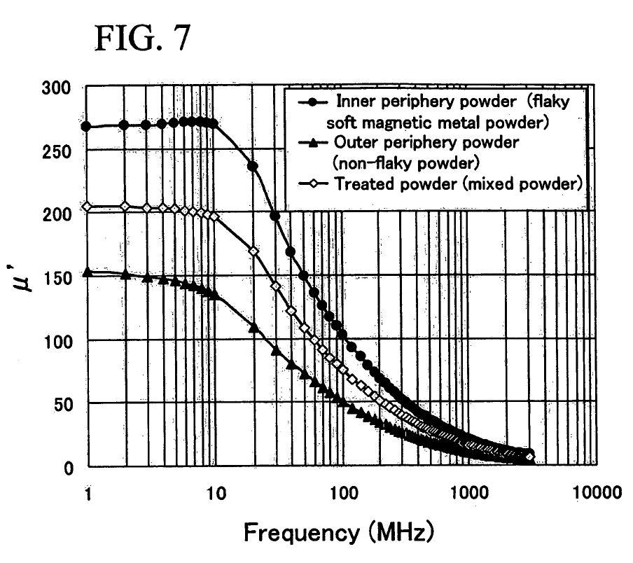

As shown in FIG. 7, the result revealed that μ′ (μ′ is the real part of the complex permeability) was 80 or less at 100 MHz (in FIG. 7, referred to as “treated powder (mixed powder)”).

Then, the treated powder obtained by pulverizing and flaking in the same manner as described above was subjected to a classifying treatment by use of a centrifugal gas-flow classifier (TC-25N, manufactured by Nisshin Engineering Inc.) having a structure similar to that of the classifier 50 shown in FIG. 4. In this classification, the rotation speed of the rotor was 1200 rpm, the flow rate of the gas fed into the chamber was 7 m³/min, and the rotor was operated for 60 to 180 min. The treatment time was varied according to the feed amount of the treated powder.

After the rotor was turned off, the powder (hereinafter referred to as the “inner peripheral powder”) recovered through the inner peripheral discharge flow channel and the powder (hereinafter referred to as the “outer peripheral powder”) recovered through the outer peripheral discharge flow channel were respectively observed on a SEM.

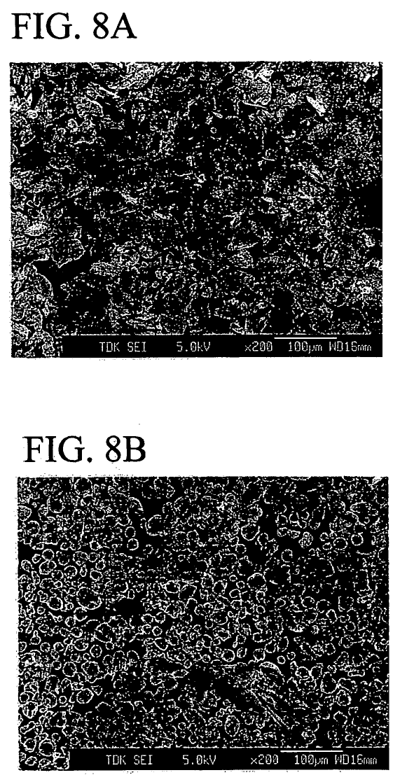

FIG. 8 shows the observed images.

It was verified that as shown in FIG. 8(a), the inner peripheral powder was almost composed of a flaky powder, and as shown in FIG. 8(b), the outer peripheral powder was almost composed of a powder maintaining the particle shape (spherical shape) of the raw material powder. Accordingly, it was confirmed that by use of a classifier 50 having a structure as shown in FIG. 4, the flaky soft magnetic metal powder (inner peripheral powder) and the non-flaky powder (outer peripheral powder) were able to be classified from each other.

The ratio (weight ratio) of the inner peripheral powder to the outer peripheral powder was measured to be approximately 7:3.

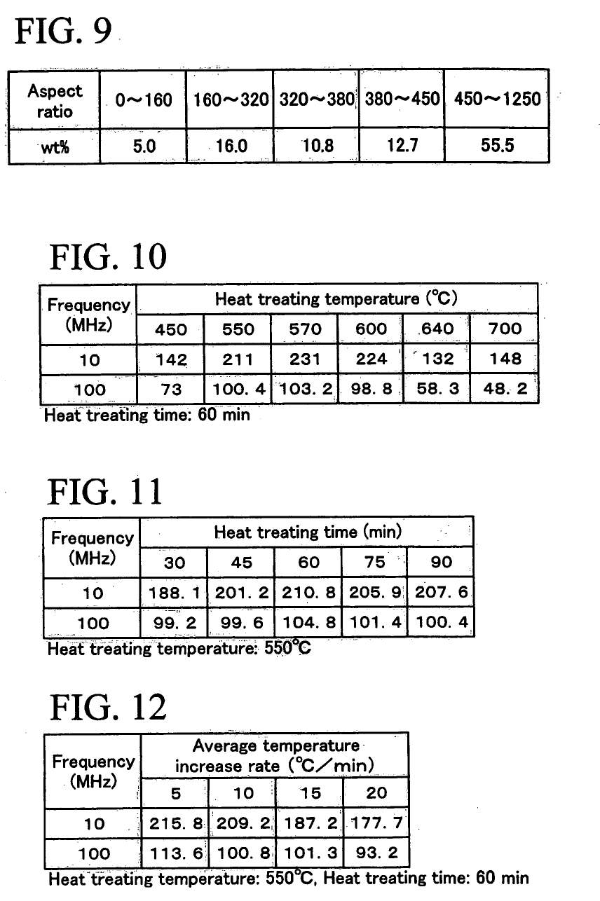

On the inner peripheral powder, the contents of the individual aspect ratio sections thereof were measured by use of a sieve classifier. The results obtained are shown in FIG. 9.

As shown in FIG. 9, in the inner peripheral powder, the sum of the contents of the aspect ratio sections thereof having the aspect ratios of 160 to 1250 amounts to 93 wt % or more, and it was verified that the non-flaky powder having aspect ratios less than 160 was almost not contained.

Then, another magnetic sheet was fabricated by using only the above described outer peripheral powder and by successively synthesizing an insulating film, heaping, rolling and heat treating in the same manner as described above.

The permeability of the magnetic sheet thus fabricated was measured.

As shown in FIG. 7, the result revealed that μ′ was of the order of 50 at 100 MHz and supported that the non-flaky powder degrades the permeability (in FIG. 7, referred to as “outer peripheral powder (non-flaky powder)”).

In addition, another magnetic sheet was fabricated by using only the above described inner peripheral powder and by successively synthesizing an insulating film, heaping, rolling and heat treating in the same manner as described above.

The permeability of the magnetic sheet thus fabricated was measured.

As shown in FIG. 7, the result revealed that μ′ was 100 or more at 100 MHz and the sheet had practically sufficient properties. Consequently, it was verified that properties are improved by fabricating a sheet containing the flaky soft magnetic metal powder in a large proportion obtained by removing the non-flaky powder (in FIG. 7, referred to as “inner peripheral powder (flaky soft magnetic metal powder)”).

The outer peripheral powder (non-flaky powder) as a recycled material was once again pulverized and flaked by passing through the same steps as described above, and thereafter subjected to the classifying treatment under the same conditions as described above by use of the gas-flow classifier.

After the classifying treatment, the weight ratio of the inner peripheral powder to the outer peripheral powder was measured to be approximately 7:3.

Another magnetic sheet was fabricated by use of the inner peripheral powder recovered after the classifying treatment in the same manner as described above, and the properties of the sheet was investigated. The result revealed that μ′ was 100 or more at 100 MHz and the sheet had practically sufficient properties. Consequently, it was verified that the recycled material could be used satisfactorily.

Accordingly, it was verified that 90 wt % or more of the initially fed raw material could be utilized as the flaky soft magnetic metal powder to fabricate the magnetic sheet.

### EXAMPLE 2

A water atomized 2 Mo permalloy powder (80 Ni-2 Mo-bal. Fe (mol %)) of about 30 μm inmeanparticle size, as a soft magnetic metal powder, was pulverized and flaked in a medium stirring mill using toluene as solvent to yield a flaky soft magnetic metal powder (hereinafter, referred to as “the flaky powder” as the case may be) having a mean particle size (D50) of about 110 μm, a particle thickness of 0.2 to 0.6 μm and an aspect ratio of 50 to 600.

Subsequently, the dried flaky powder was subjected to the insulating film synthesis treatment by using perhydropolysilazane (polysilazane NL110A-20, manufactured by Clariant Japan Co., Ltd.) as the insulating material to form the insulating phase 13. In this treatment, the addition amount of perhydropolysilazane to the flaky Mo permalloy powder was set at 4.5 wt %. The flaky Mo permalloy powder and perhydropolysilazane were mixed together at room temperature for about 60 min by use of a mixer. Then, the mixture was maintained in the air at 300° C. for 60 min to convert perhydropolysilazane to SiO₂ to form an insulating film on the surface of the particles of the flaky Mo permalloy powder.

Then, the above described flaky powder subjected to insulating treatment was heaped nearly uniformly on a stainless steel substrate while sifting the flaky powder by use of a sieve (opening: 125 μm) located 10 to 20 mm above the substrate. The stainless steel substrate was rolled bypassing it through a two-stage cold rolling roll of 50 mm in roll diameter, and the individual particles of the flaky powder were thereby oriented parallel to the substrate to form an about 50 μm thick sheet.

Successively, this sheet was heat treated in an atmosphere of nitrogen under the conditions shown in FIGS. 10 to 13 for the purpose of relieving the strain generated in the pulverizing step to flatten the metal powder and the strain generated in rolling.

Each of the magnetic sheets thus obtained was subjected to the permeability measurements at 10 MHz and 100 MHz. The results obtained are shown in FIGS. 10 to 13.

As shown in FIG. 10, it was verified that by setting the heat treating temperature between 550 and 600° C., the permeability μ at a frequency of 10 MHz was made to be 200 or more, and furthermore, by setting the heat treating temperature to fall within a range from 550 to 570° C., the permeability μ at a frequency of 10 MHz was made to be 200 or more and the permeability μ at a frequency of 100 MHz was also made to be 100 or more.

As shown in FIG. 11, it was verified that by setting the heat treating time at 45 min or more, the permeability μ at a frequency of 10 MHz was made to be 200 or more, and furthermore, by setting the heat treating time at 60 min or more, the permeability p at a frequency of 10 MHz was made to be 200 or more and the permeability μ at a frequency of 100 MHz was also made to be 100 or more.

As shown in FIG. 12, it was verified that by setting the average temperature increase rate at 15° C./min or less until the heat treating temperature was reached, the permeability μ at a frequency of 100 MHz was made to be 100 or more, and furthermore, by setting the same rate at 10° C./min or less, the permeability μ at a frequency of 10 MHz was made to be 200 or more and the permeability μ at a frequency of 100 MHz was also made to be 100 or more.

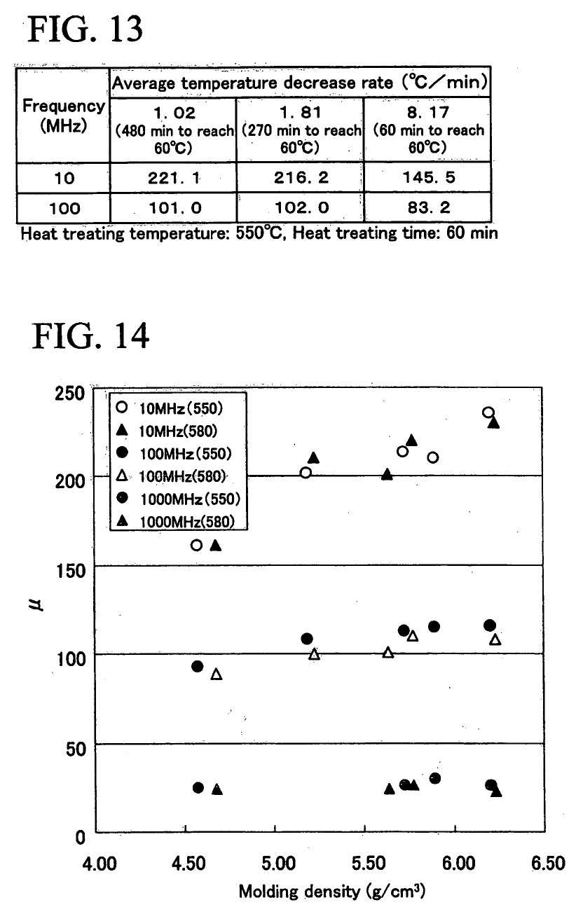

As shown in FIG. 13, it was verified that by setting the average temperature decrease rate after heat treating at 2° C./min or less, the permeability μ at a frequency of 10 MHz was made to be 200 or more and the permeability μ at a frequency of 100 MHz was also made to be 100 or more.

### EXAMPLE 3

In the same manner as in Example 2, a flaky powder was prepared and subjected to the insulating treatment, and thereafter rolled and heat treated to yield a magnetic sheet. In the rolling step, the molding density was varied within a range from 4.5 to 6.3 g/cm³.

As for the heat treating conditions, two different heat treating temperatures of 550° C. and 580° C. were applied, and the heat treating time was set at 60 min, the average temperature increase rate was set at 5° C./min and the temperature decrease rate was set that the temperature was decreased down to 60° C. over 480 min.

For each of the magnetic sheets fabricated as described above, the permeability measurements at 10 MHz and 100 MHz were carried out. The results obtained are shown in FIG. 14.

As shown in FIG. 14, it was verified that by setting the molding density in the rolling step at 5.2 g/cm³ or more, the permeability μ at a frequency of 10 MHz was made to be 200 or more and the permeability μ at a frequency of 100 MHz was also made to be 100 or more.

### EXAMPLE 4

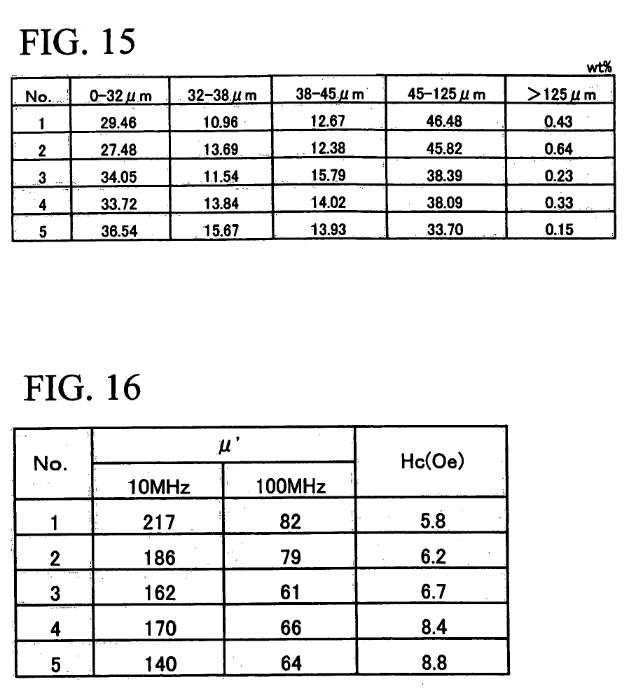

A water atomized 2 Mo permalloy powder (80 Ni-2 Mo-bal.Fe (mol %)) of about 30 μmin mean particle size, as a soft magnetic metal powder, was pulverized and flaked in a medium stirring mill using toluene as solvent. By varying the pulverizing time, there were obtained five different types (different with respect to the major axis) flaky soft magnetic metal powders (hereinafter, each referred to as a “flaky powder” as the case may be) shown in FIG. 15. The particle thickness of each of the flaky soft magnetic metal powders fell within a range from 0.1 to 0.3 μm. FIG. 15 shows the weight ratios (wt %) for the individual particle size ranges in each of the flaky soft magnetic metal powders.

Each of the obtained flaky soft magnetic metal powders was heat treated at 560° C. for 60 min, and thereafter subjected to a coercive force (Hc; hereinafter simply referred to as Hc) measurement. The results obtained are shown in FIG. 16.

Each of the flaky powders pulverized and flaked was dried and thereafter was subjected to the insulating film synthesis treatment by using perhydropolysilazane (polysilazane NL110A-20, manufactured by Clariant Japan Co., Ltd.) as the insulating material to form the insulating phase 13. In this treatment, the addition amount of perhydropolysilazane to the flaky Mo permalloy powder was set at 4.5 wt %. The flaky Mo permalloy powder and perhydropoly silazane were mixed together at room temperature for about 60 min by use of a mixer. Then, the mixture was maintained in the air at 300° C. for 60 min to convert perhydropolysilazane to SiO₂ to form an insulating film on the surface of the particles of the flaky Mo permalloy powder.

Then, each of the above described flaky powders subjected to insulating treatment was heaped nearly uniformly in thickness on a stainless steel substrate. The stainless steel substrate was rolled by passing it through a two-stage cold rolling roll of 50 mm in roll diameter, and the individual particles of the flaky powder were thereby oriented parallel to the substrate to form an about 50 μm thick sheet.

Successively, this sheet was heat treated in an atmosphere of nitrogen at 560° C. for 60 min for the purpose of relieving the strain generated in rolling.

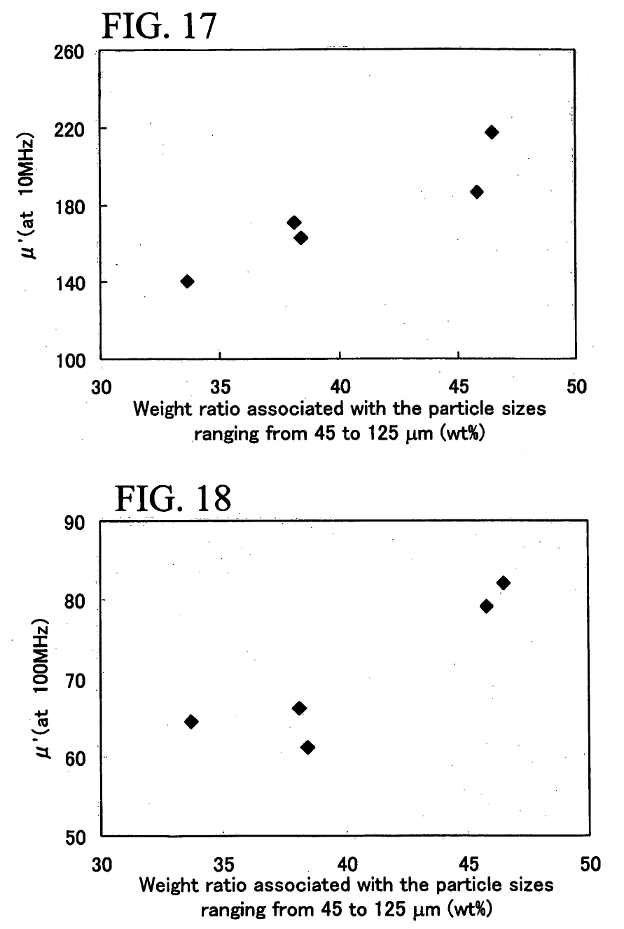

Each of the sheets obtained as described above was subjected to the measurements of the real part (μ′; hereinafter, simply referred to as μ′) of the complex permeability at 10 MHz and 100 MHz. The results obtained are shown in FIG. 16. The graphs in FIGS. 17 and 18 respectively show the relations between the μ′ values and the weight ratios (wt %) of the fractions of the flaky powders falling in a particle-size range from 45 to 125 μm.

Thereafter, for the purpose of reinforcing of and imparting insulating property to the sheets, the sheets were soaked in a xylene solution (20%) of a room temperature curable silicone resin for about 20 min, and then dried to yield sheet-like products to form electromagnetic wave absorbing sheets 1.

As can be seen from FIGS. 16 to 18, as the proportion of the flaky powder falling within a major-axis range from 45 to 125 μm is increased, μ′ is increased. The flaky powders exhibiting high μ′ values are low in Hc, and on the contrary, the flaky powders exhibiting high in Hc, are degraded in μ′. Accordingly, in the present invention, the proportion of the flaky powder falling in a particle-size range from 45 to 125 μm is set at 40 wt % or more. The proportion of the flaky powder falling in a major-axis range from 45 to 125 μm is preferably 50 wt % or more, and more preferably 70 wt % or more.

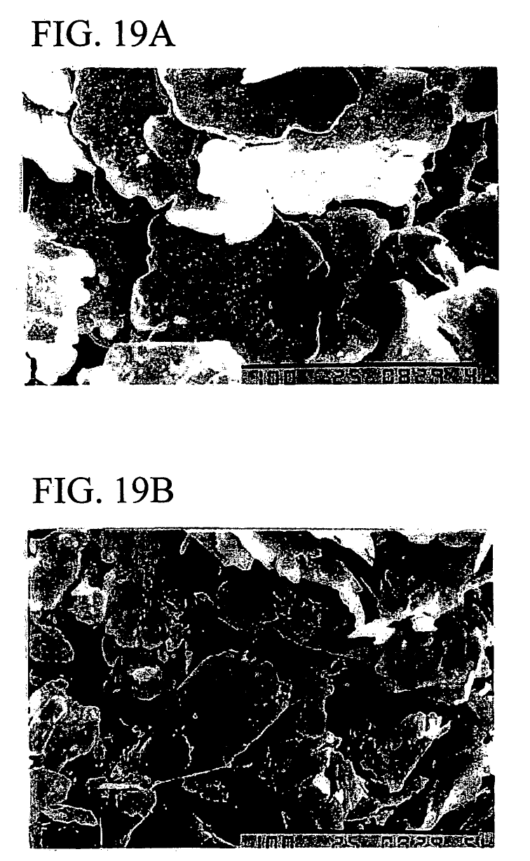

The fact that the Hc values of the individual flaky powders are different from each other as described above may be understood to be caused by the different internal strains generated in pulverizing. More specifically, the individual flaky powders are different from each other in pulverizing time as described above; in the present example, the heat treating was carried out for the purpose of removing strain, but the internal strains were not removed only by heat treating, so that the Hc values were increased as the pulverizing time was increased. FIGS. 19A and 19B present exterior appearance-showing micrographs of the flaky powders of No. 1 and No. 5 in FIG. 15, respectively. As compared to the flaky powder of No. 1, the flaky powder of No. 5 exhibited irregularly-shaped particles such as particles with torn peripheries and particles with finely split peripheries. This may be understood that in the flaky powder of No. 1 in FIG. 15 a proper flaking was carried out, but in the flaky powder of No. 5 in FIG. 15, after a proper flattening had been carried out, individual powder particles were further underwent pulverizing to be irregularly shaped as described above.

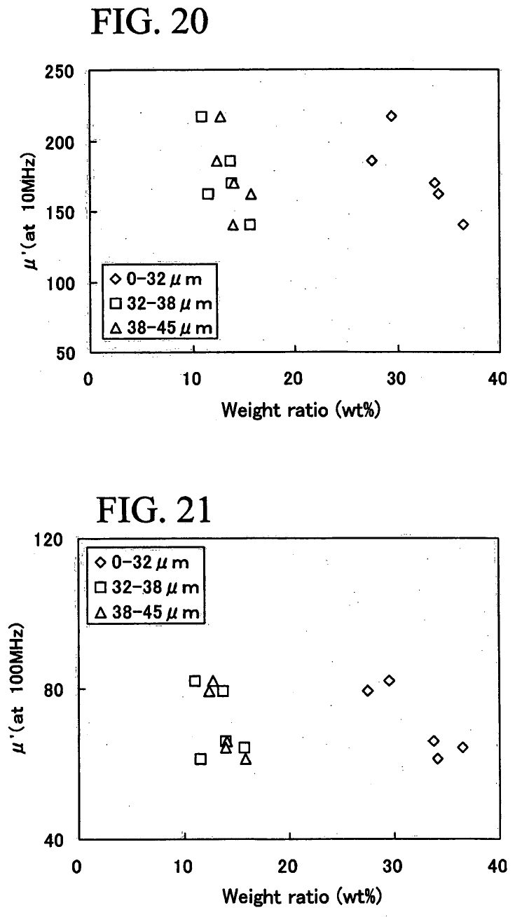

FIGS. 20 and 21 show the relations between the μ values and the weight ratios of the fractions of the flaky powder respectively falling in the major-axis ranges from 0 to 32 μm, from 32 to 38 μm and from 38 to 45 μm. In each of these particle size ranges, as the ratio of the concerned particle size range is decreased, the μ′ value is increased. In the case of No. 1 (FIGS. 15 and 16) having the highest μ′ value, the content of the flaky powder falling in the major-axis range from 0 to 32 μm amounts to 30 wt % or less, and the content of the flaky powder falling in the major-axis range from 32 to 45 μm amounts to 25 wt % or less.

What is claimed is:

1. A method for producing an electromagnetic wave absorbing sheet, comprising the steps of:
obtaining a treated powder by subjecting a raw material powder to a pulverizing and flaking treatment;
classifying the treated powder into a soft magnetic metal powder (a) having an aspect ratio of a specified value or more and a soft magnetic metal powder (b) having an aspect ratio less than the specified value;
forming an insulating film on the surface of the soft magnetic metal powder (a);
producing a sheet-like product by bonding the particles of the soft magnetic metal powder (a) to each other through applying pressure under the condition such that there is heaped the soft magnetic metal powder (a) having the insulating film formed thereon; and
heat treating the sheet-like product.

2. The method for producing an electromagnetic wave absorbing sheet according to claim 1, wherein in the step of classifying the treated powder, the treated powder is classified by placing the treated powder in a gas flow circling in a chamber.

3. The method for producing an electromagnetic wave absorbing sheet according to claim 2, wherein in the step of classifying the treated powder, the soft magnetic metal powder (a) is recovered from the inner periphery part in the chamber, and the soft magnetic metal powder (b) is recovered from the outer periphery part in the chamber.

4. The method for producing an electromagnetic wave absorbing sheet according to claim 1, wherein the soft magnetic metal powder (b) is recycled as the raw material powder used in the step of obtaining the treated powder.

5. The method for producing an electromagnetic wave absorbing sheet according to claim 1, wherein in the heat treating step, the sheet-like product is placed in a heat treating furnace, the heat treating furnace is heated at an average temperature increase rate of 15° C./min or less, and the sheet-like product is heat treated at heat treating temperatures of 400 to 800° C.

6. The method for producing an electromagnetic wave absorbing sheet according to claim 5, wherein in the heat treating step, the average temperature increase rate up to the heat treating temperatures is set at 10° C./min or less.

7. The method for producing an electromagnetic wave absorbing sheet according to claim 5, wherein in the heat treating step, the heat treating temperatures are set at 520 to 590° C.

8. The method for producing an electromagnetic wave absorbing sheet according to claim 5, wherein in the heat treating step, the heat treating temperatures are maintained for 60 min or more.

9. The method for producing an electromagnetic wave absorbing sheet according to claim 5, wherein in the heat treating step, the heat treating temperatures are maintained over a predetermined period of time, and thereafter the heat treating furnace is cooled down at an average temperature decrease rate of 3° C./min or less.

10. A method for classifying a powder, comprising:
placing a mixture of a first powder and a second powder different from each other in shape in a gas flow circling in a chamber; and
classifying the first powder and the second powder by recovering the first powder from the inner periphery part in the chamber and by recovering the second powder from the outer periphery part in the chamber.

11. The method for classifying a powder according to claim 10, wherein the first powder and the second powder are classified on the basis of the difference between the centrifugal force and the drag acting on each of the first powder and the second powder in the gas flow.

12. The method for classifying a powder according to claim 10, wherein the first powder is larger in aspect ratio than the second powder.

13. The method for classifying a powder according to claim 10, wherein the mixture is a soft magnetic metal powder to be used as a raw material for a magnetic layer having an electromagnetic wave absorptivity in the electromagnetic wave absorbing sheet.

14. An electromagnetic wave absorbing sheet, comprising:
a magnetic layer formed by laminating in layers particles of the flaky soft magnetic metal powder having an insulating film formed on the surface thereof in the thickness direction; and
an insulating layer formed of an insulating material; wherein
93 wt % or more of the flaky soft magnetic metal powder has an aspect ratio of 160 to 1250.

15. The electromagnetic wave absorbing sheet according to claim 14, wherein 40 wt % or more of the flaky soft magnetic metal powder has a particle size of 45 to 125 μm.

16. The electromagnetic wave absorbing sheet according to claim 15, wherein 30 wt % or less of the flaky soft magnetic metal powder has a particle size of 32 μm or less.

17. The electromagnetic wave absorbing sheet according to claim 15, wherein 25 wt % or less of the flaky soft magnetic metal powder has a particle size of 32 to 45 μm.

18. The electromagnetic wave absorbing sheet according to claim 15, wherein the flaky soft magnetic metal powder has a particle thickness of 0.1 to 1.0 μm.

19. The electromagnetic wave absorbing sheet according to claim 15, wherein the flaky soft magnetic metal powder has a coercive force (Hc) of 6.5 Oe or less.
